(19) United States
(12) Patent Application Publication
(10) Pub. No.: US 2011/0234451 A1
(43) Pub. Date: Sep. 29, 2011

(54) METHOD AND DEVICE FOR DISTANCE MEASUREMENT

(75) Inventors: Ulrich Bock, Braunschweig (DE); Bernhard Evers, Braunschweig (DE); Lars Schnieder, Braunschweig (DE)

(73) Assignee: SIEMENS AKTIENGESELLSCHAFT, MUENCHEN (DE)

(21) Appl. No.: 13/132,002

(22) PCT Filed: Nov. 11, 2009
(86) PCT No.: PCT/EP2009/064958

§ 371 Date: May 31, 2011

(30) Foreign Application Priority Data
Nov. 28, 2008 (DE) 10 2008 060 188.8

(51) Int. Cl. G01S 13/58; G01S 13/08

(52) U.S. Cl. 342/109; 342/118

(57) ABSTRACT

A method and a device provide distance measurement between two points or one point on a path and a rail vehicle. In order to achieve a high measurement accuracy, the measurement of the propagation time of a radio frequency identification (RFID) signal is provided between the points or the point on a path and the rail vehicle.

The invention relates to a method and an apparatus for distance measurement between two track points or one track point and a rail vehicle. The accuracy of the distance measurements for position and speed determination purposes is of fundamental importance for railroad control and safety technology since safety-relevant functions are implemented on this basis for automatic train control and train protection.

In this case, the distance between position reference points, for example Eurobalises or automatic train control coupling coils, is subject to particularly stringent precision requirements. These track point distances must be measured with an accuracy of down to ±1 cm, in order, for example, to allow sufficiently accurate position and speed measurement for track-bound local public transport with a high train frequency. It is known for tachymeters and triple mirrors to be used, with infrared light being reflected and its delay time being evaluated. Tachymeters and triple mirrors must for this purpose be aligned precisely with respect to one another, which is very difficult when the distances between the position reference points are up to 700 m.

Furthermore, separation measurements and speed measurements derived therefrom which are as accurate as possible are required for calibration of speed sensors. Calibration is carried out by comparison of the sensor measured values with a reference or a standard. A calibration value in order to correct the measured values from the speed sensor is derived from the discrepancy between two values. Regular calibration is required for all odometric systems, for example radar sensors in vehicles and trackside radar sensors. Until now, various sensor systems which operate in particular using the difference measurement principle have been used for calibration, that is to say as a reference or standard. Position pulse transmitters are frequently used for this purpose, based on counting wheel revolutions. One general problem is the measurement uncertainty of the reference systems, for example because of the skidding effect and sliding effect in the case of position pulse transmitters.

The invention is based on the object of specifying a method and an apparatus which allow more reliable and more accurate distance measurement.

With regard to the method, the object is achieved in that the delay time of an RFID (radio-frequency identification) signal is measured between the track points or the track point and the rail vehicle.

An apparatus for carrying out the method as claimed in claim 4 for this purpose has an RFID transmitter/receiver which is associated with a first track point and an RFID receiver/transmitter which is associated with a second track point, or an RFID receiver/transmitter which is associated with the rail vehicle as well as means for delay-time measurement of an RFID signal between the first and the second track points or between the first track point and the rail vehicle.

The delay time of the RFID signal, which represents a measure of the distance and whose rate of change therefore represents a position and speed measure, can be determined easily with very high accuracy. The RFID signal may in this case be transmitted bidirectionally or unidirectionally. In the latter arrangement, either the first track point is equipped with an RFID transmitter and the second track point or the rail vehicle is equipped with an RFID transmitter, or vice versa. The RFID components can be positioned easily, and there is no need for precise alignment between the transmitter and receiver.

According to claim 2, the delay time of the RFID signal is measured between position reference points, in particular Eurobalises and/or coupling coils. RFID transmitters and receivers are particularly suitable for being positioned precisely vertically above the two position reference points, thus allowing the distance to be measured with high precision by means of the signal delay time.

According to claim 3, the speed of the rail vehicle is determined as a function of the delay time of the RFID signal and is used for calibration of speed sensors, in particular Doppler radar sensors. In contrast to the position pulse transmitters which are normally used for calibration, the RFID measurement system operates independently of skidding and sliding effects, thus allowing the calibration to be carried out more precisely.

When using RFID components for distance measurement, their robustness and small size are also advantageous, thus allowing temporary use, as required, without any problems.

The invention will be explained in the following text with reference to exemplary embodiments which are illustrated in the figures, in which:

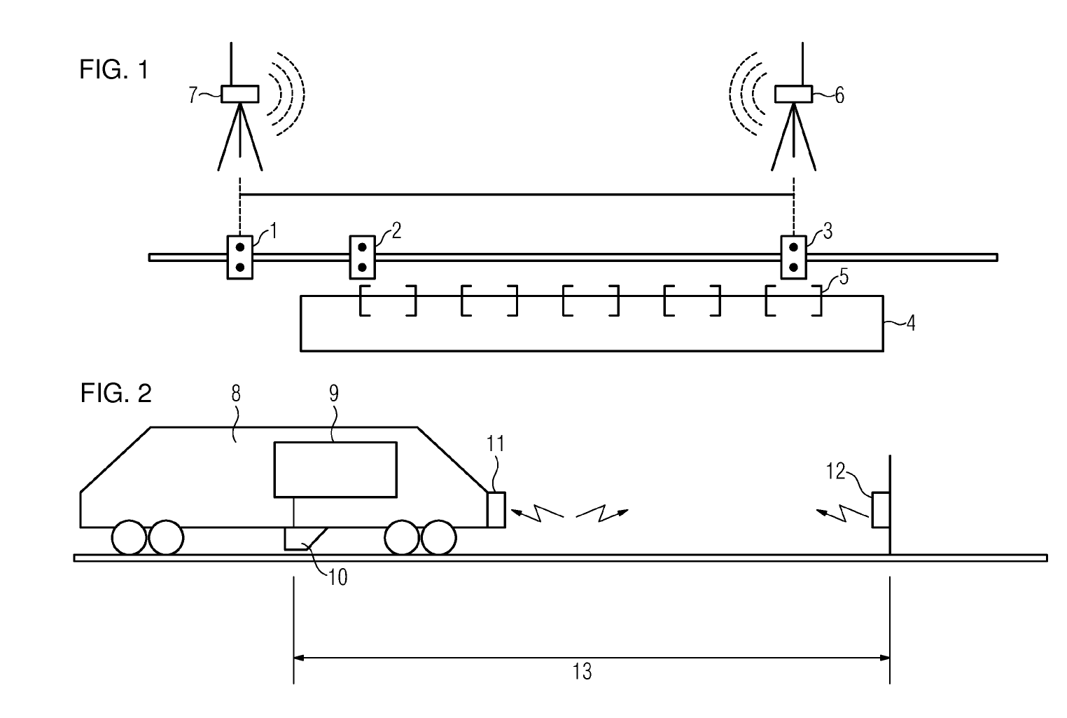

FIG. 1 shows a system for measurement of position reference points, and

FIG. 2 shows a system for calibration of speed sensors.

FIG. 1 shows three position reference points in the form of Eurobalises 1, 2, 3, the distance between which is to be measured. The Eurobalise 3 is in this case associated with a planned stopping point of a rail vehicle adjacent to a platform 4 with platform doors 5. In order to guarantee that a rail vehicle comes to rest exactly at the stopping point identified by the Eurobalise 3, such that the platform doors 5 are aligned with the vehicle doors, it is necessary to precisely note the distance of the first and second Eurobalises 1 and 2 from the third Eurobalise 3. When the rail vehicle moves past the Eurobalises 1 and 2, a braking curve, which is dependent on the actual speed, is determined and monitored in the vehicle. This braking process must be carried out with extremely high precision, particularly when automatic operation, that is to say driverless operation, is envisaged. For this purpose, an RFID transmitter and/or receiver 6 is arranged vertically above the Eurobalise 3, and is arranged with an RFID receiver and/or transmitter 7 vertically above the Eurobalise 1—as illustrated—or vertically above the Eurobalise 2. The delay time of a continuously transmitted RFID signal is measured, and is used as a distance measure between the position reference points.

A further application for RFID signal delay-time measurement is the calibration of a speed sensor as illustrated in FIG. 2. The figure shows a rail vehicle 8 with a vehicle appliance 9 which interacts with a Doppler radar sensor 10 for speed determination. In order to calibrate the Doppler radar sensor 10, an RFID transmitter/receiver 11 is fitted at least at times to the front end of the rail vehicle 8, and interacts with a trackside reference RFID transmitter/receiver 12. A very precise distance equivalent can be produced from the delay time of the RFID signal between the two RFID components 11 and 12. At the end of reference path 13 between the Doppler radar sensor 10 and the transmission, the results of the speed measurement by means of the Doppler radar sensor 10 and by means of the RFID signal are compared. The difference between the measurement results is converted to a calibration factor, and is finally used for calibration of the Doppler radar sensor 10.

1-4. (canceled)

5. A method for distance measurement between two track points or one track point and a rail vehicle, which comprises the step of:
measuring a delay time of a radio-frequency identification (RFID) signal between the track points or the track point and the rail vehicle.

6. The method according to claim 5, which further comprises measuring a delay time of the RFID signal between position reference points.

7. The method according to claim 5, which further comprises determining a speed of the rail vehicle in dependence on the delay time of the RFID signal and using the speed determined for calibration of speed sensors.

8. The method according to claim 5, which further comprises measuring a delay time of the RFID signal between Eurobalises.

9. The method according to claim 5, which further comprises measuring a delay time of the RFID signal between coupling coils.

10. The method according to claim 7, which further comprises providing Doppler radar sensors as the speed sensors.

11. An apparatus for measuring distances between two track points, the apparatus comprising:
a radio-frequency identification (RFID) transmitter/receiver associated with a first track point;
an RFID receiver/transmitter associated with a second track point; and
means for delay-time measurement of an RFID signal between the first and the second track points.

12. An apparatus for measuring distances between one track point and a rail vehicle, the apparatus comprising:
a radio-frequency identification (RFID) transmitter/receiver associated with a first track point;
an RFID receiver/transmitter associated with the rail vehicle; and
means for delay-time measurement of an RFID signal between the first track point and the rail vehicle.
